(19) United States
(12) Patent Application Publication
(10) Pub. No.: US 2021/0168177 A1
(43) Pub. Date: Jun. 3, 2021

(54) GENERATING MEETING THREADS USING DIFFERENT COLLABORATION MODALITIES

(71) Applicant: Cisco Technology, Inc., San Jose, CA (US)

(72) Inventors: Andrew Henderson, Spiddal (IE); Stewart Curry, Dun Laoghaire (IE); Keith Griffin, Oranmore (IE)

(21) Appl. No.: 16/701,511

(22) Filed: Dec. 3, 2019

(51) Int. Cl. H04L 29/06; G10L 15/26; G06F 3/16; G10L 15/22

(52) U.S. Cl. CPC H04L 65/403; G10L 15/26; G10L 2015/223; G10L 15/22; G06F 3/167

(57) ABSTRACT

In accordance with an embodiment, a method is provided. First text is obtained by speech-to-text conversion of speech of a first participant of a collaboration event. Second text typed by a second participant of the collaboration event, who is connected as a text-only participant to the collaboration event, is received. A meeting thread is generated in a message space of the collaboration event using the first text and the second text. The meeting thread is provided for display on user devices associated at least with the first participant and the second participant.

### TECHNICAL FIELD

The present disclosure relates to collaboration events.

### BACKGROUND

Collaboration events or online/web-based meetings may be conducted between participants connected over a network. A meeting transcript may be generated and saved for a meeting separately from any text message conversations associated with the meeting. As a result, the meeting transcription does not relate to the message activity.

### BRIEF DESCRIPTION OF THE DRAWINGS

FIG. 1 is a diagram illustrating an example communication environment in which a collaboration event is supported and a meeting thread is generated that uses different collaboration modalities, according to an example embodiment.

FIG. 2 is a screenshot of a graphical user interface (GUI) screen that may be used for participation in a collaboration event and illustrating a meeting thread depicting different collaboration modalities, according to an example embodiment.

FIG. 3 is a screenshot of a GUI screen that may be used for participation in a collaboration event and illustrating a meeting thread depicting different collaboration modalities, according to another example embodiment.

FIG. 4 is a screenshot of a GUI screen that may be used for concurrent participation in a plurality of collaboration events and in which a meeting thread is generated, for at least one of the collaboration events, that uses different collaboration modalities, according to an example embodiment.

FIG. 5 is an illustration of a user device displaying content with text overlaying the content during a collaboration event, according to an example embodiment.

FIG. 6 is a flowchart of a method for generating a meeting thread depicting different collaboration modalities, according to an example embodiment.

FIG. 7 is a hardware block diagram of a computing apparatus that may be configured to perform operations of user devices described herein, according to an example embodiment.

FIG. 8 is a hardware block diagram of a computing apparatus that may be configured to perform operations of a collaboration server described herein, according to an example embodiment.

### DESCRIPTION OF EXAMPLE EMBODIMENTS

Overview

In accordance with an embodiment, a method is provided. First text is obtained by speech-to-text conversion of speech of a first participant of a collaboration event. Second text typed by a second participant of the collaboration event, who is connected as a text-only participant to the collaboration event, is received. A meeting thread is generated in a message space of the collaboration event using the first text and the second text. The meeting thread is provided for display on user devices associated at least with the first participant and the second participant.

### EXAMPLE EMBODIMENTS

Presented herein is a method and system in which a meeting thread is provided that interleaves a meeting transcription with the associated messaging activity so that other space participants can join and participate in the meeting without joining on audio or video.

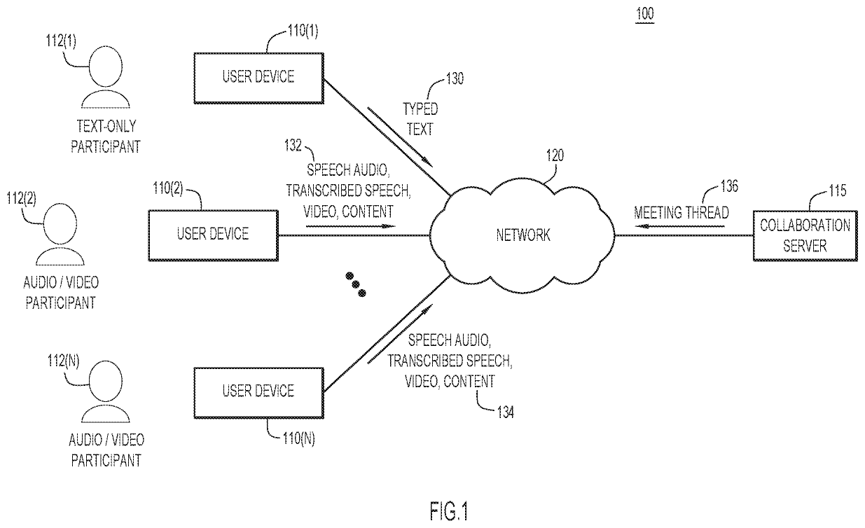

With reference made to FIG. 1, a diagram is shown of a communication environment 100 in which embodiments may be deployed. Communication environment 100 includes a plurality of user devices 110(1)-110(N), which may be operated by respective users 112(1)-112(N), and a collaboration server 115. The user devices 110(1)-110(N) and the collaboration server 115 may communicate with the user devices 110(1)-110(N) via network 120.

The collaboration server 115 may host and/or otherwise provide a collaboration service that allows for collaboration events to be conducted over the network 120. As used herein, a collaboration event is an online meeting or other collaborative session space. The collaboration session space may include webpages to which multiple user devices connected to mimic a collaborative environment in which users can converse in audio, video, and text, and share content (documents, presentations, videos, images, etc.). The collaboration server 115 may receive, for example, typed text, speech audio, transcribed speech, video, audio, and content from the user devices 110(1)-110(N). The collaboration server 115 may use some or all of this information to generate a meeting thread of the collaboration event.

The user devices 110(1)-110(N) may each take on a variety of forms, including a smartphone, tablet, laptop computer, desktop computer, video conference endpoint, and the like. The users 112(1)-112(N) may connect as participants to one or more collaboration events managed by the collaboration server 115 via their respective user devices 110(1)-110(N). Some users may connect to the collaboration event as text-only participants, while other users may connect to the collaboration event as audio/video participants. A text-only participant is a participant of a collaboration event that communicates as part of the collaboration event using only typed text. A user device of a user who is connected as a text-only participant may provide to the collaboration server 115 text that has been typed by the text-only participant. An audio/video participant is a participant of a collaboration event that communicates using audio and/or video. A user device of an audio/video participant may provide, for example, speech, audio, transcribed speech, video, and/or content to the collaboration server 115 as part of a collaboration event.

FIG. 1 shows an example in which the user 112(1) of user device 110(1) is connected as a text-only participant to a collaboration event, and the user 112(2) of user device 110(2) and user 112(N) of user device 110(N) are connected as audio/video participants to the same collaboration event. Text-only participant user 112(1) may type text using the user device 110(1) to communicate with the audio/video participants users 112(2) and 112(N) as part of the collaboration event. In the example shown in FIG. 1, at 130, the user device 110(1) provides the typed text (the text typed by the text-only participant user 112(1)) to the collaboration server 115 via the network 120.

In the example shown in FIG. 1, at 132, the user device 110(2) provides speech (speech audio and/or transcribed speech) that it detects, to the collaboration server 115 via the network 120. The user device 110(2) may detect speech of the audio/video participant user 112(2). At 134, the user device 110(N) provides speech (speech audio and/or transcribed speech) that it detects, to the collaboration server 115 via the network 120. The user device 110(N) may detect speech of the audio/video participant user 112(N). The speech detected by the user devices 110(2) and 110(N) may be transcribed into text, for example, using speech-to-text conversion capabilities of the user devices 110(2) and 110(N). The speech-to-text conversion capabilities may include natural language processing (NLP), which may be employed, for example, for determining user intent. In other words, NLP may be employed as a service to understand what a user's speech means (e.g., in the context of the collaboration event, the user's speech, other user's speech, etc.) in order for an appropriate action to be taken in the meeting thread. NLP may also be employed, for example, for correcting text that is converted from speech.

In an example embodiment, the user devices 110(2) and 110(N) may be responsible for providing speech audio for transcription (e.g., by the collaboration server 115), and the collaboration server 115 may be responsible for transcribing the speech audio into text. For example, speech that is detected by the user device 110(2) may be provided as speech audio to the collaboration server 115 via the network 120, and the collaboration server 115 may transcribe the speech audio into text. Similarly, speech that is detected by the user device 110(N) may be provided as speech audio to the collaboration server 115 via the network 120, and the collaboration server 115 may transcribe the speech audio into text.

The collaboration server 115 may generate a meeting thread in a message space of the collaboration event using typed text that is received from the user device 110(1) and using text obtained by speech-to-text conversion of speech of at least one of the user 110(2) and the user 110(N). The collaboration server 115 may generate the meeting thread to include, in a spatial relation to the text obtained by speech-to-text conversion in a chronological order of occurrence.

In the example shown in FIG. 1, at 136, the collaboration server 115 provides the meeting thread to the user devices 110(1)-110(N) via the network 120 for display.

While FIG. 1 shows a single collaboration server 115, it is to be understood that there may be multiple collaboration severs distributed throughout a geographical area in order to support numerous collaboration events and load balancing of workload.

The collaboration server 115 may reside or be deployed in, for example, a cloud computing environment, an on-premise computing environment, and/or in a hybrid computing environment. It is to be understood that the collaboration server 115 is not limited to any particular deployment.

Network 120 may be any one or more of a local area network (LAN), a wired network, a wireless network, and wide area network (WAN), including the Internet. In FIG. 1, network 120 is shown as a single network for simplicity, however, it is to be understood that in some embodiments, network 120 may include a combination of networks.

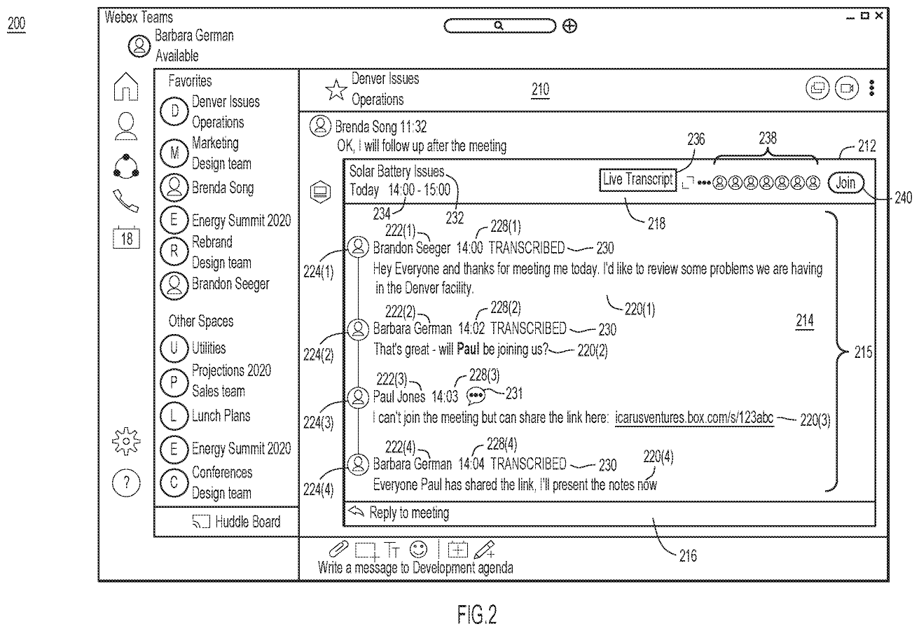

With reference to FIG. 2, shown is a screenshot of an example graphical user interface (GUI) screen 200 that may be used for participation in a collaboration event, according to an example embodiment. The GUI screen 200 includes a “teams” space 210 called “Denver Issues”. The teams space 210 includes a collaboration event space 212 of a collaboration event called “Solar Battery Issues” that is live or ongoing. The collaboration event space 212 includes a message space 214, a text input window 216, and a collaboration event information section 218.

In the example of FIG. 2, the collaboration event is being attended by a plurality of users, some who are connected as text-only participants and some who are connected as audio/video participants. As the collaboration event is being conducted, text representing transcribed speech of audio/video participants and text representing typed text of text-only participants are added to the message space 214 to create a meeting thread 215. The text may be added dynamically to the message space 214 and presented in a chronological order of occurrence.

As shown in the example of FIG. 2, the meeting thread 215 includes text messages 220(1)-220(4). Text message 220(1) represents text transcribed from speech of user “Brandon Seeger”, who is connected as an audio/video participant to the collaboration event. Text message 220(2) represents text transcribed from speech of user “Barbara German,” who is connected as an audio/video participant to the collaboration event. Text message 220(3) represents text that has been typed by user “Paul Jones”, who is connected as a text-only participant to the collaboration event. For example, text that is typed in the text input window 216 may be added to the meeting thread 215. Text message 220(4) represents text transcribed from speech of the user “Barbara German” at a later time. In the example of FIG. 2, text messages 220(1)-220(4) are displayed in a chronological order of occurrence from top to bottom of the message space 214. The GUI screen 200 shown in FIG. 2 is an example of the user interface that the participant “Barbara German” would be presented with on her user device.

During the collaboration event, the user “Brandon Seeger” is the first user to participate. The user “Brandon Seeger” speaks the following “Hey everyone and thanks for meeting me today. I'd like to review some problems we are having in the Denver facility.” This speech is transcribed into the text message 220(1) that is displayed in the message space 214. The user “Barbara German” is next to participate and speaks the following “That's great—will Paul be joining us?” This speech is transcribed into the text message 220(2) that is displayed in the message space 214. The user “Paul Jones” is next to participate and types the following text into a text input area “I can't join the meeting but can share the link here: icarusventures.box.com/s/123abc.” This typed text is displayed in the message space 214. The user “Barbara German” then participates again and speaks the following “Everyone Paul has shared the link, I'll present the notes now.” This speech is transcribed into the text message 220(4) that is displayed in the message space 214.

In the example of FIG. 2, it may be determined that the user “Paul Jones” is identified in the text of text message 220(2). For example, the name “Paul” in the text 220(2) may be compared to a meeting roster or team roster to make the determination. In response to the determination, the user “Paul Jones” may be notified as being mentioned in the text message 220(2) and/or may be connected to the collaboration event as a text-only participant.

NLP may be employed to determine whether the user “Paul Jones” is merely being mentioned (a passive trigger) or is being asked to do something (an active trigger). In an example, regardless of whether the user “Paul Jones” is determined to be mentioned in the text message 220(2) as an active or passive trigger, the user “Paul Jones” may be notified as being mentioned in the text message 220(2) and/or connected to the collaboration event as a text-only participant. In another example, whether the user “Paul Jones” is determined to be mentioned as an active or passive trigger may determine whether the user “Paul Jones” is notified as being mentioned in the text message 220(2) and/or is connected to the collaboration event as a text-only participant. For example, if it is determined that the user “Paul Jones” is mentioned in the text message 220(2) as a passive trigger, the user “Paul Jones” may not be notified of being mentioned in the text message 220(2) and/or may not be connected to the collaboration event as a text-only participant, whereas if it is determined that the user “Paul Jones” is mentioned in the text message 220(2) as an active trigger, the user “Paul Jones” may be notified of being mentioned in the text message 220(2) and/or may be connected to the collaboration event as a text-only participant or perhaps as an audio/video participant.

As shown in the example of FIG. 2, each of text messages 220(1)-220(4) may be displayed with participant identifiers (e.g., a name and/or an avatar) indicative of the user who is the source of the speech or typed the text. For example, the text message 220(1), which corresponds to speech of the user “Brandon Seeger,” is displayed in a spatial relation with the name 222(1) and the avatar 224(1). Similarly, the text messages 220(2)-220(4) may be displayed in a spatial relation, respectively, with names 222(2)-222(4) and avatars 224(2)-224(4). Because the text messages 220(2) and 220(4) correspond to speech of the same user, “Barbara German,” the names 222(2) and 222(4) may be the same as each other, and the avatars 224(2) and 224(4) may be the same as each other.

As shown in the example of FIG. 2, each of text messages 220(1)-220(4) may be associated with a respective timestamp 228(1)-228(4), which, for example, may be indicative of a respective time of occurrence. A time of occurrence may be a time at which a respective text is added to the meeting thread 215, a time at which typed text is submitted via a text input space, a time at which speech audio is generated from speech of an audio/video participant, a time at which transcribed speech is generated from speech audio of an audio video/participant, or any other suitable time. The timestamps 228(1)-228(4) may be presented in a spatial relation with its corresponding text messages 220(1)-220(4).

In the meeting thread 215, typed text and transcribed text may be visually differentiated from each other. In other words, text in the meeting thread 215 may be displayed with one or more visual characteristics or identifiers that is/are indicative of a modality in which a user participants in a collaboration event. The meeting thread 215 may include a modality identifier that visually differentiates text representing text transcribed from speech (e.g., text messages 220(1), 220(2), 220(4)) from text message representing typed text (e.g., text message 220(3)).

As shown in FIG. 2, a modality identifier “TRANSCRIBED” 230 is displayed in association with each of the text messages 220(1), 220(2), 220(4) to identify this text as text that has been transcribed from speech. The text message 220(3), for example, may be displayed in association with a modality identifier icon/emoji 231 that identifies the text message 220(3) as text that has been typed, or it may be that a lack of a modality identifier is indicative of the text message as being text that has been typed. It is to be understood that any visual characteristics of the text itself or displayed in association with the text message may be used a modality identifier. For example, the text message itself or an identifier displayed in association with the text may have visual characteristics such as a font, font size, bolding, italicizing, underlining, highlighting, color, a particular icon or emoji, etc. that may be used to differentiate between text representing text transcribed from speech from text representing typed text.

In the example shown, the collaboration event information section 218 includes a collaboration event title 232, a collaboration event date/time indicator 234, a live transcript indicator 236, a meeting roster 238, and a join button 240. It is to be understood that the collaboration event information section 218 may include additional or alternative information related to the collaboration event.

The live transcript indicator 236 may indicate that the collaboration event is live or active, and that a meeting thread is being generated or is to be generated for the collaboration event using transcribed speech and typed text.

The meeting roster 238 includes information identifying participants of the collaboration event. As shown in FIG. 2, the meeting roster may include avatars of participants who are currently connected to the collaboration event and/or users invited to the collaboration event. The meeting roster 238 may distinguish between audio/video participants and text-only participants of the collaboration event. The meeting roster 238 may identify participants currently connected to the collaboration event.

The join button 240 may be selected for a user to join the collaboration event via audio/video. For example, after selecting the join button 240, the user may be connected as an audio/video participant to the collaboration event and may begin sharing audio and/or video.

In an example, comments or contributions may be made after the collaboration event has ended. Such comments may be visually differentiated from comments or contributions made during the collaboration event.

In an example, generation of a meeting thread may be opted into by a host of the meeting and/or other participants.

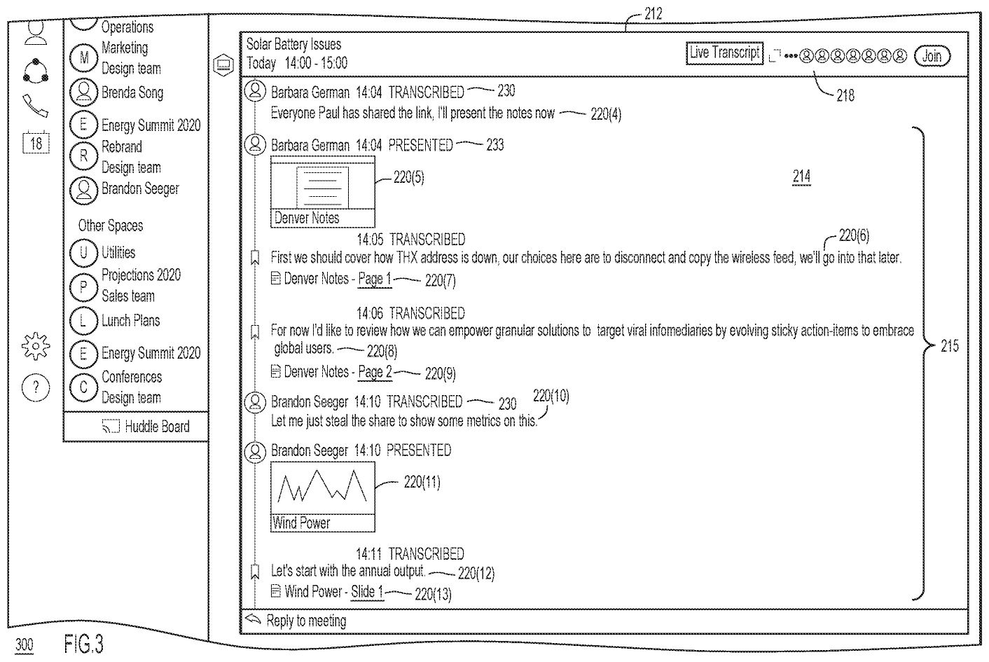

With reference to FIG. 3, shown is a screenshot of an example graphical user interface (GUI) screen 300 that may be used for participation in a collaboration event, according to an example embodiment. The GUI screen 300 is the same as the GUI screen 200 shown in FIG. 2, except that the meeting thread 215 further includes visual representations of content shared by participants of the collaboration event, and shows text corresponding to additional contributions by the users “Brandon Seeger” and “Barbra German.” FIG. 3 shows the meeting thread 215 at a later time than in FIG. 2. The visual representations of content shared by the participants may be presented in a spatial relation to text corresponding to the participant's contribution.

For example, during the collaboration event, the user “Barbara German” presents the content “Denver Notes,” and a visual representation of the content “Denver Notes” being presented 220(5) is added to the meeting thread 215. The user “Barbara German” speaks, and her speech is transcribed into the text message 220(6) that is added to the meeting thread 215 and displayed in the message space 214. A visual representation of the content “Denver Notes—Page 1” 220(7) is then added to the meeting thread 215 and displayed in the message space 214. The user “Barbara German” speaks again, and her speech is transcribed into the text message 220(8) that is added to the meeting thread 215 and displayed in the message space 214. A visual representation of the content “Denver Notes—Page 2” 220(9) is then added to the meeting thread 215 and displayed in the message space 214.

The user “Brandon Seeger” is next to participate, and his speech is transcribed into the text message “220(1)” that is added to the meeting thread 215 and displayed in the message space 214. At a later time during the collaboration event, the user “Brandon Seeger” presents the content “Wind Power” during the collaboration event, and a visual representation of the content being presented 220(11) is added to the meeting thread 215. The user “Brandon Seeger” speaks again, and his speech is transcribed in the text message 220(12) that is added to the meeting thread 215 and displayed in the message space 214. A visual representation of the content “Window Power—Slide 1” 220(13) is then added to the meeting thread 215 and displayed in the message space 214.

Visual representations of the content being presented 220(5), 220(7), 220(9), and 220(13) may be one or more screenshots of some or all of the presented content and/or one or more links to some or all of the presented content. Slide summarization technology, for example, may be used to enable the addition to the meeting thread of the visual representations of the content being presented.

In an example, visual representations of presented content may be periodically generated and added to the meeting thread 215 during the collaboration event. The visual representations of content may be added automatically and/or manually to the meeting thread 215. To manually add a visual representation of content to a meeting thread during a collaboration event, for example, a participant may be prompted for input, and based on the received input, the visual representation of content may be added to the meeting thread. For example, the user “Barbara German” may present the content “Denver Notes,” and may be prompted via the GUI screen 300 for input indicative of whether a visual representation of the content “Denver Notes” is to be added to the meeting thread 215. In response to receiving an indication that a visual representation of the content “Denver Notes” should be added to the meeting thread 215, the visual representation of the content “Denver Notes” may be added to the meeting thread 215 (e.g., by the collaboration server 115).

In an example, content may be attached pre-meeting as part of a meeting invite for the meeting (e.g., as an agenda document and/or a read-ahead of slides) and/or post-meeting (e.g., a recording of the meeting may be attached). This content may be the same as or different from any content presented during the meeting. The meeting thread 215, for example, may then, in effect, be or represent a comprehensive log and content bundle of the collaboration event.

Visual representations of presented content may be displayed in the meeting thread 215 in a spatial relation with participant identifiers of the participant who presents the content. For example, visual representations of presented content may be displayed in the meeting thread 215 in a spatial relation with a modality identifier “PRESENTED” 233 to identify the visual representation of the presented content as such.

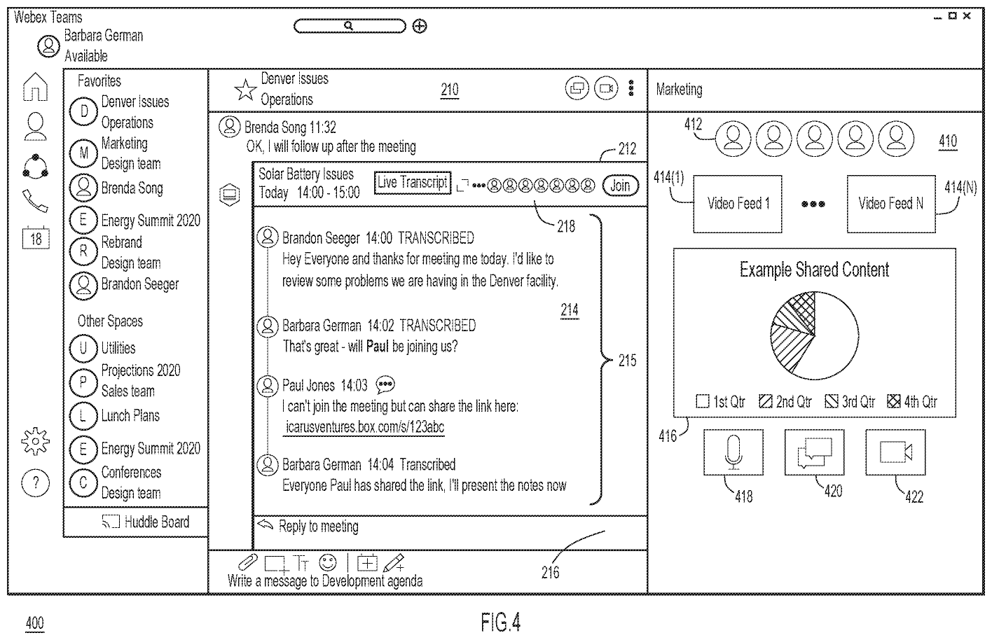

With reference now to FIG. 4, shown is a screenshot of an example graphical user interface (GUI) screen 400 that may be used for concurrent participation in a plurality of collaboration events, according to an example embodiment. The GUI screen 400 is the same as the GUI screen 200 shown in FIG. 2, except that the GUI screen 400 additionally shows simultaneous participation in another collaboration event. As such, FIG. 4 shows a user who is concurrently a text-only participant of one collaboration event and an audio/video participant of another collaboration event. As shown in the example of FIG. 4, the GUI screen 400 additionally includes collaboration event space 410 of a collaboration event. The collaboration event space 410 corresponds to a GUI that may be presented to a participant who is connected to another collaboration event as an audio/video participant. The collaboration event space 410 includes participant icons 412 indicative of participants of the collaboration event. These participants may include text-only participants and/or audio/video participants.

The collaboration event space 410 includes video feed sections 414(1)-414(N), which may display video of N audio/video participants of the collaboration event who are providing video from their respective user devices.

The collaboration event space 410 includes shared content section 416, which may display content being shared by a participant of the collaboration event, an audio button 418 which may be selectable for enabling or disabling the audio from the user's device, and a video button 420 which may be selectable for enabling or disabling the video from the user's device.

The collaboration event space 410 also includes a meeting thread button 422 which may be selectable for switching from being connected as an audio/video participant to being connected as a text-only participant. Alternatively, the meeting thread button 422 may be selectable for displaying a meeting thread of the collaboration event, while the user remains connected as an audio/video participant.

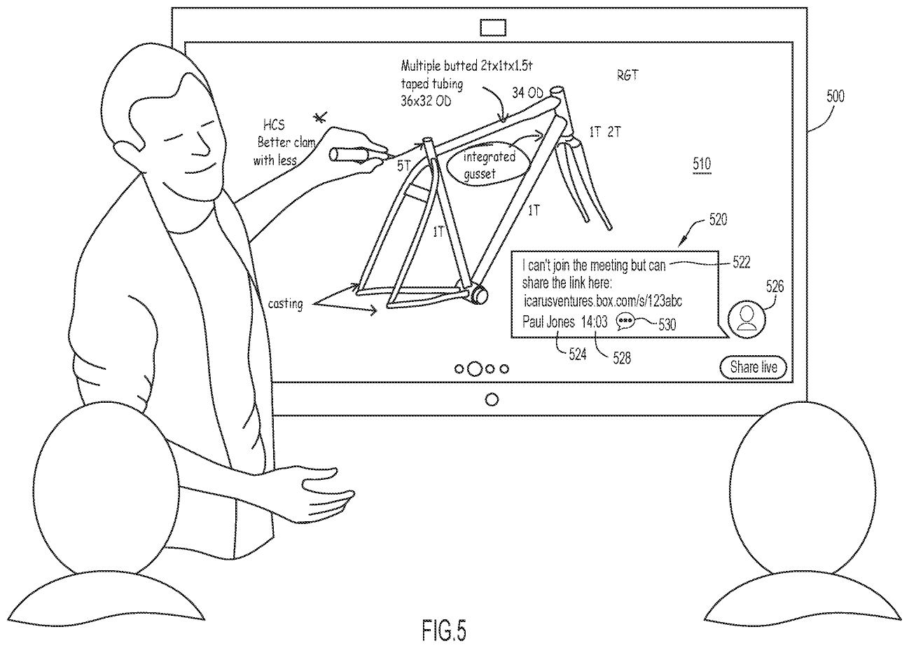

With reference now to FIG. 5, shown is an illustration of a user device 500 displaying content 510 of a collaboration event with a text message notification 520 overlaying the content 510 during a collaboration event, according to an example embodiment. In this example, the user device 500 is a collaboration whiteboard device. The user device 500 is being used by users who are connected as audio/video participants to the collaboration event. As shown, the text message notification 520 indicating that a text message from a user Paul Jones is received and is displayed by the user device 500 in a manner that overlays the content 510 of the collaboration event that is being displayed.

In the example shown in FIG. 5, the text message notification 520 includes a text message 522, a participant name 524, an avatar 526, a time 528, and a modality identifier icon/emoji 530. The participant name 524 and/or the avatar 526 may be indicative of an identity of the user who typed and sent the text message 522, and are shown in FIG. 5 as “Paul” with a picture of Paul, respectively. The time 528 may be indicative of a time, for example, that the text message 522 was sent by Paul or received into the collaboration event.

The text message notification 520 may overlay the content 510 for a predetermined amount of time, after which some or all of the text message notification 520 may be, for example, removed from display or minimized. In an example, instead of or in addition to the text message notification 520 being displayed, the text message notification 520 may be read aloud using text-to-speech technology.

In an example, participants may have an option of configuring whether to allow text message notifications to be overlaid or otherwise displayed on respective user devices of audio/video participants.

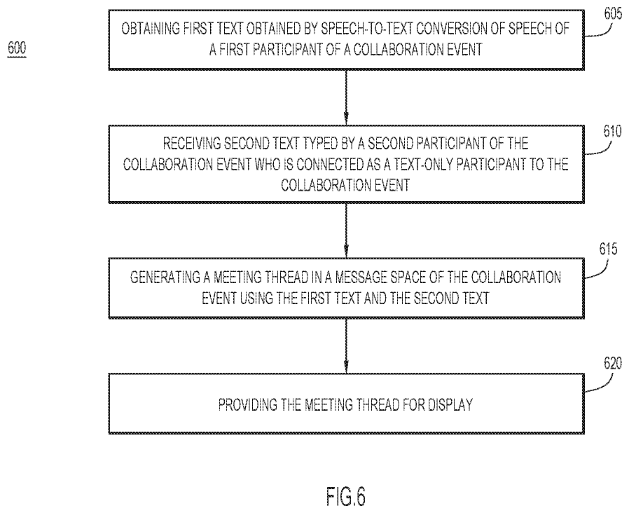

With reference now to FIG. 6, shown is a flowchart of an example method 600 for generating a meeting thread, according to an example embodiment.

At 605, the method 600 includes obtaining first text by speech-to-text conversion of speech of a first participant of a collaboration event. In one example embodiment, obtaining the first text may include receiving, from a user device associated with the first participant of the collaboration event, speech of the first participant, and transcribing the speech of the first participant into the first text. In another example embodiment, obtaining the first text may include receiving the first text from a user device associated with the first participant of the collaboration event.

At 610, the method 600 includes receiving second text typed by a second participant of the collaboration event who is connected as a text-only participant to the collaboration event. In an example embodiment, the second participant may be concurrently a text-only participant of the collaboration event and an audio/video participant of another collaboration event, such as depicted in FIG. 4.

At 615, the method 600 includes generating a meeting thread in a message space of the collaboration event using the first text and the second text. In an example embodiment, generating the meeting thread may include providing, in a spatial relation to the first text, a visual representation of content shared by the first participant. In an example embodiment, the meeting thread may include a modality identifier that visually differentiates the first text representing text transcribed from speech from the second text representing typed text. In another example embodiment, the meeting thread may include first and second participant identifiers indicative, respectively, of the first and second participants.

At 620, the meeting thread is provided for display on user devices associated at least with the first participant and the second participant. In an example embodiment, providing for display may include providing the first text and the second text for display in a chronological order of occurrence.

In an example embodiment, the method 600 may further include converting the second text into speech data representing the second text, and providing, for audio output, the speech data representing the second text to a user device associated with the first participant.

In an example embodiment, the method 600 may further include determining, based on the first text, that the second participant is identified in the first text, and connecting, in response to determining that the second participant is identified in the first text, the second participant to the collaboration event as a text-only participant.

In an example embodiment, the method 600 may further include providing the second text for display by a user device associated with the first participant in a manner that overlays displayed content of the collaboration event with the second text, as depicted, in FIG. 5, for example.

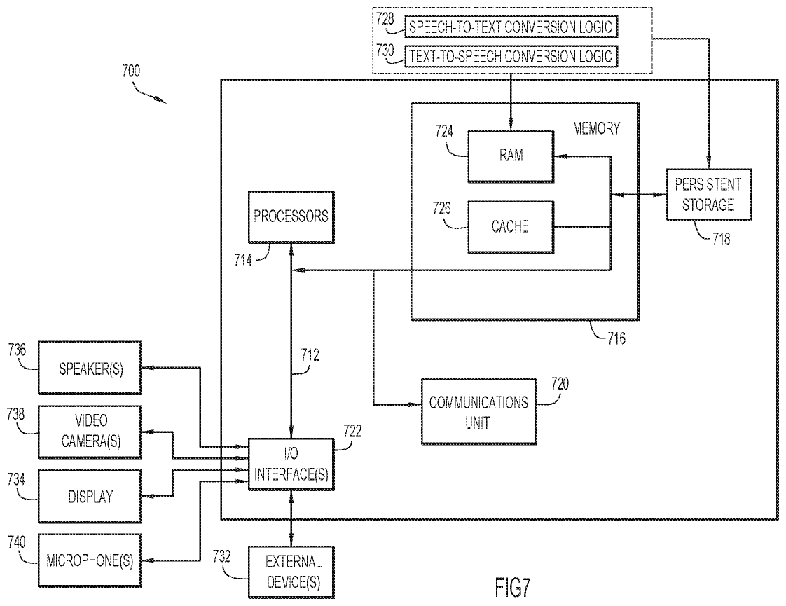

FIG. 7 illustrates a hardware block diagram of a computing device 700 that may perform the functions of any of the user devices referred to herein in connection with FIGS. 1-6. It should be appreciated that FIG. 7 provides only an illustration of one embodiment and does not imply any limitations with regard to the environments in which different embodiments may be implemented. Many modifications to the depicted environment may be made.

As depicted, the device 700 includes a bus 712, which provides communications between computer processor(s) 714, memory 716, persistent storage 718, communications unit 720, and input/output (I/O) interface(s) 722. Bus 712 can be implemented with any architecture designed for passing data and/or control information between processors (such as microprocessors, communications and network processors, etc.), system memory, peripheral devices, and any other hardware components within a system. For example, bus 712 can be implemented with one or more buses.

Memory 716 and persistent storage 718 are computer readable storage media. In the depicted embodiment, memory 716 includes random access memory (RAM) 724 and cache memory 726. In general, memory 716 can include any suitable volatile or non-volatile computer readable storage media. Instructions for the “Speech-to-Text Conversion Logic” 728 and the “Text-to-Speech Conversion Logic” 730 may be stored in memory 716 or persistent storage 718 for execution by processor(s) 714.

One or more programs may be stored in persistent storage 718 for execution by one or more of the respective computer processors 714 via one or more memories of memory 716. The persistent storage 718 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 718 may also be removable. For example, a removable hard drive may be used for persistent storage 718. Other examples include optical and magnetic disks, thumb drives, and smart cards that are inserted into a drive for transfer onto another computer readable storage medium that is also part of persistent storage 718.

Communications unit 720, in these examples, provides for communications with other data processing systems or devices. In these examples, communications unit 720 includes one or more network interface cards. Communications unit 720 may provide communications through the use of either or both physical and wireless communications links.

I/O interface(s) 722 allows for input and output of data with other devices that may be connected to computer device 700. For example, I/O interface 722 may provide a connection to external devices 732 such as a keyboard, keypad, a touch screen, and/or some other suitable input device. External devices 732 can also include portable computer readable storage media such as database systems, thumb drives, portable optical or magnetic disks, and memory cards.

Software and data used to practice embodiments can be stored on such portable computer readable storage media and can be loaded onto persistent storage 718 via I/O interface(s) 722. I/O interface(s) 722 may also connect to a display 734. Display 734 provides a mechanism to display data to a user and may be, for example, a computer monitor. I/O interface(s) 722 may also connect to speaker(s) 736, video camera(s) 738, and/or microphone(s) 740.

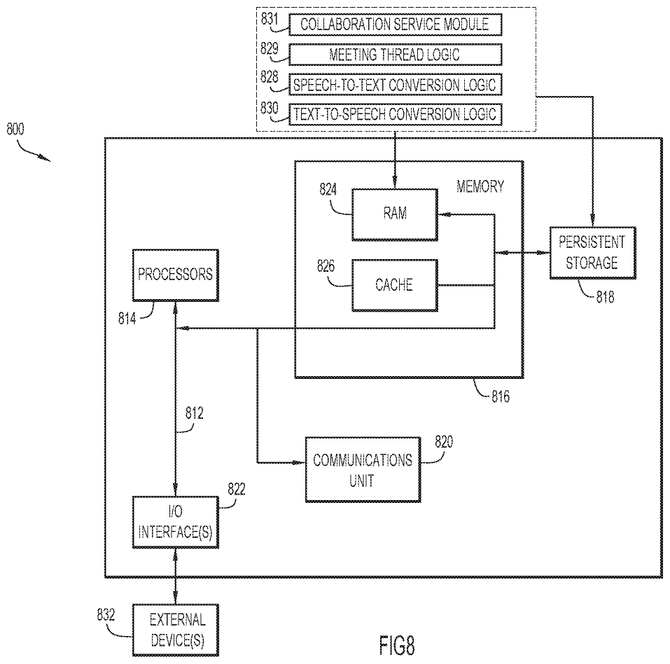

FIG. 8 illustrates a hardware block diagram of a computing device 800 that may perform the functions of a collaboration server referred to herein in connection with FIGS. 1-6. It should be appreciated that FIG. 6 provides only an illustration of one embodiment and does not imply any limitations with regard to the environments in which different embodiments may be implemented. Many modifications to the depicted environment may be made.

As depicted, the device 800 includes a bus 812, which provides communications between computer processor(s) 814, memory 816, persistent storage 818, communications unit 820, and input/output (I/O) interface(s) 822. Bus 812 can be implemented with any architecture designed for passing data and/or control information between processors (such as microprocessors, communications and network processors, etc.), system memory, peripheral devices, and any other hardware components within a system. For example, bus 812 can be implemented with one or more buses.

Memory 816 and persistent storage 818 are computer readable storage media. In the depicted embodiment, memory 816 includes RAM 824 and cache memory 826. In general, memory 816 can include any suitable volatile or non-volatile computer readable storage media. Instructions for the “Speech-to-Text Conversion Logic” 828, “Meeting Thread Logic” 829, “Text-to-Speech Conversion Logic” 830, and “Collaboration Service Module Logic” 831 may be stored in memory 816 or persistent storage 818 for execution by processor(s) 814.

One or more programs may be stored in persistent storage 818 for execution by one or more of the respective computer processors 814 via one or more memories of memory 816. The persistent storage 818 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 818 may also be removable. For example, a removable hard drive may be used for persistent storage 818. Other examples include optical and magnetic disks, thumb drives, and smart cards that are inserted into a drive for transfer onto another computer readable storage medium that is also part of persistent storage 818.

Communications unit 820, in these examples, provides for communications with other data processing systems or devices. In these examples, communications unit 820 includes one or more network interface cards. Communications unit 820 may provide communications through the use of either or both physical and wireless communications links.

I/O interface(s) 822 allows for input and output of data with other devices that may be connected to computer device 800. For example, I/O interface 822 may provide a connection to external devices 832 such as a keyboard, keypad, a touch screen, and/or some other suitable input device. External devices 832 can also include portable computer readable storage media such as database systems, thumb drives, portable optical or magnetic disks, and memory cards.

Software and data used to practice embodiments can be stored on such portable computer readable storage media and can be loaded onto persistent storage 818 via I/O interface(s) 822.

The programs described herein are identified based upon the application for which they are implemented in a specific embodiment. However, it should be appreciated that any particular program nomenclature herein is used merely for convenience, and thus the embodiments should not be limited to use solely in any specific application identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other repositories, queue, etc.). The data transmitted between entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., Graphical User Interface (GUI), command-line, prompt, etc.) for obtaining or providing information (e.g., data relating to teams spaces, collaboration events, collaboration event spaces), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, etc.) and databases or other repositories arranged in any desired fashion, where the present embodiments may be applied to any desired type of computing environment (e.g., cloud computing, client-server, network computing, mainframe, stand-alone systems, etc.). The computer or other processing systems employed by the present embodiments may be implemented by any number of any personal or other type of computer or processing system (e.g., desktop, laptop, PDA, mobile devices, etc.), and may include any commercially available operating system and any combination of commercially available and custom software (e.g., machine learning software, etc.). These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present embodiments may alternatively be implemented by any type of hardware and/or other processing circuitry.

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The embodiments presented may be in various forms, such as a system, a method, and/or a computer program product at any possible technical detail level of integration. The computer program product may include a computer readable storage medium (or media) having computer readable program instructions thereon for causing a processor to carry out aspects of presented herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects presented herein.

Aspects of the present embodiments are described herein with reference to flowchart illustrations and/or block diagrams of methods, apparatus (systems), and computer program products according to the embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, in one form, a method is provided comprising: obtaining first text by speech-to-text conversion of speech of a first participant of a collaboration event; receiving second text typed by a second participant of the collaboration event who is connected as a text-only participant to the collaboration event; generating a meeting thread in a message space of the collaboration event using the first text and the second text; and providing the meeting thread for display on user devices associated at least with the first participant and the second participant.

In another form, an apparatus is provided comprising: a network interface unit configured for communications over a network; and a processor coupled to the network interface unit and configured to: obtain first text by speech-to-text conversion of speech of a first participant of a collaboration event; receive second text typed by a second participant of the collaboration event who is connected as a text-only participant to the collaboration event; generate a meeting thread in a message space of the collaboration event using the first text and the second text; and provide the meeting thread for display on user devices associated at least with the first participant and the second participant.

Further still, in yet another form, one or more non-transitory computer readable storage media are provided encoded with instructions that, when executed by a processor, cause the processor to: obtain first text by speech-to-text conversion of speech of a first participant of a collaboration event; receive second text typed by a second participant of the collaboration event who is connected as a text-only participant to the collaboration event; generate a meeting thread in a message space of the collaboration event using the first text and the second text; and provide the meeting thread for display on user devices associated at least with the first participant and the second participant.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
obtaining first text by speech-to-text conversion of speech of a first participant of a collaboration event;
receiving second text typed by a second participant of the collaboration event who is connected as a text-only participant to the collaboration event;
generating a meeting thread in a message space of the collaboration event using the first text and the second text; and
providing the meeting thread for display on user devices associated at least with the first participant and the second participant.

2. The method of claim 1, wherein obtaining the first text comprises:
receiving, from a user device associated with the first participant, speech of the first participant of the collaboration event; and
transcribing the speech of the first participant of the collaboration event into the first text.

3. The method of claim 1, wherein obtaining the first text comprises receiving the first text from a user device associated with the first participant of the collaboration event.

4. The method of claim 1, further comprising:
converting the second text into speech data representing the second text; and
providing, for audio output, the speech data representing the second text to a user device associated with the first participant.

5. The method of claim 1, further comprising providing the second text for display by a user device associated with the first participant in a manner that overlays displayed content of the collaboration event with the second text.

6. The method of claim 1, wherein the meeting thread includes a modality identifier that visually differentiates the first text representing text transcribed from speech from the second text representing typed text.

7. The method of claim 1, wherein the meeting thread includes first and second participant identifiers indicative, respectively, of the first and second participants.

8. The method of claim 1, further comprising:
determining, based on the first text, that the second participant is identified in the first text; and
connecting, in response to determining that the second participant is identified in the first text, the second participant to the collaboration event as a text-only participant.

9. The method of claim 1, wherein generating the meeting thread includes providing, in a spatial relation to the first text, a visual representation of content shared by the first participant.

10. The method of claim 1, wherein providing for display comprises providing the first text and the second text for display in a chronological order of occurrence.

11. The method of claim 1, wherein the second participant is concurrently a text-only participant of the collaboration event and an audio/video participant of another collaboration event.

12. An apparatus comprising:
a network interface unit configured for communications over a network; and
a processor coupled to the network interface unit and configured to:
obtain first text by speech-to-text conversion of speech of a first participant of a collaboration event;
receive second text typed by a second participant of the collaboration event who is connected as a text-only participant to the collaboration event;
generate a meeting thread in a message space of the collaboration event using the first text and the second text; and
provide the meeting thread for display on user devices associated at least with the first participant and the second participant.

13. The apparatus of claim 12, wherein the processor is further configured to:
receive, from a user device associated with the first participant, speech of the first participant of the collaboration event; and
transcribe the speech of the first participant of the collaboration event into the first text.

14. The apparatus of claim 12, wherein the processor is further configured to receive the first text from a user device associated with the first participant of the collaboration event.

15. The apparatus of claim 12, wherein the processor is further configured to provide the first text and the second text for display in a chronological order of occurrence.

16. The apparatus of claim 12, wherein the processor is further configured to generate the meeting thread by providing in a spatial relation to the first text, a visual representation of content shared by the first participant.

17. One or more non-transitory computer readable storage media encoded with instructions that, when executed by a processor, cause the processor to:
obtain first text by speech-to-text conversion of speech of a first participant of a collaboration event;
receive second text typed by a second participant of the collaboration event who is connected as a text-only participant to the collaboration event;
generate a meeting thread in a message space of the collaboration event using the first text and the second text; and
provide the meeting thread for display on user devices associated at least with the first participant and the second participant.

18. The non-transitory computer readable storage media of claim 17, wherein the instructions, when executed by the processor, further cause the processor to:
receive, from a user device associated with the first participant, speech of the first participant of the collaboration event; and
transcribe the speech of the first participant of the collaboration event into the first text.

19. The non-transitory computer readable storage media of claim 17, further comprising instructions to cause the processor to generate by providing, in a spatial relation to the first text, a visual representation of content shared by the first participant.

20. The non-transitory computer readable storage media of claim 17, wherein the instructions, when executed by the processor, provide by providing the first text and the second text for display in a chronological order of occurrence.
